(19) United States
(12) Patent Application Publication
(10) Pub. No.: US 2012/0097503 A1
(43) Pub. Date: Apr. 26, 2012

(54) STORAGE DEVICE AND IMPROVED TRANSPORT SYSTEM

(76) Inventor: Philippe Moutie, Neuilly Sur Seine (FR)

(21) Appl. No.: 13/263,722

(22) PCT Filed: Apr. 8, 2010
(86) PCT No.: PCT/EP2010/054643

§ 371 Date: Dec. 15, 2011

(30) Foreign Application Priority Data
Apr. 8, 2009 (FR) 0952308

(51) Int. Cl. B65G 25/08

(52) U.S. Cl. 198/750.1

(57) ABSTRACT

A storage device, such as a case, in particular for storing goods, the device comprising a storage housing, characterized in that it further comprises: a rack element (10) intended to engage with driving means in order to move the device or with another rack element in order to immobilize the device, a resting surface (11) intended to engage with a support element, the resting surface being adjacent to the rack element, and means intended to engage with the immobilizing elements.

### TECHNICAL FIELD

The invention relates to the domain of storage devices and transport systems, especially for the storage and transport of merchandise and everyday consumer products.

More particularly, the invention relates to storage devices via cassettes containing what is generally described as “small packages”, that is, products or merchandise of a quantity of the order of magnitude of a consumption centre, as well as transport systems of these storage devices.

The invention also relates more generally to a transport and distribution system of said cassettes for conveying merchandise contained in the storage devices to their final destination, that is, the consumption centre.

### TECHNICAL BACKGROUND

“Consumption centre” is understood as a person or a group of people (for example a family, a co unity, a crèche, a canteen . . . ) living in the same place and consuming everyday products.

Containers or mini-containers for transporting merchandise, for example everyday products (food, household, personal care and beauty . . . ) are known from the prior art. These containers are smaller in size (volume generally less than 1 m³) for storing a quantity of products of an order of magnitude of one or more areas of consumption and staying manageable.

The state of the art discloses mini-containers of plastic bin type which enclose products within the scope of transport logistics of the distribution centre (for example a shop) to the consumption centre (for example a family apartment). These mini-containers of plastic bin type are filled at the distribution centre, then closed, preferably hermetically, using a cover, and are then stored in a transport vehicle, for example a truck or van.

By way of the transport vehicle the bins are taken right to the consumption centre where the plastic bins are unloaded so that the ordered products can be utilised. Such logistics are known especially in terms of products ordered via Internet.

Documents WO 2006/040421 and U.S. Pat. No. 3,724,628 are also known which describe a storage device associated with a transport system of this device.

However, problems have arisen with the use of these solutions of the state of the art.

First, mini-containers are most generally handled manually (filling, storage in a vehicle and transport, and drop-off at the consumption centre . . . ), which necessarily imposes minimal handling time and limits the number of orders per person assigned to process the bins.

Second, a bin is generally intended for one area, and there is no provision for filling the bin with merchandise ordered by several areas of consumption without risk of confusing the different merchandise destinations.

Third, problems have arisen as to storage of those bins which cannot easily be stowed in a transport device, risking for example displacement of the bins within the transport means, and therefore resulting in deterioration of merchandise inside the bins or any element impacted by one of the bins.

In this field, documents U.S. Pat. No. 4,279,337, WO 2005/005289 and WO 97/15514 are also known which concern a storage device further comprising a rack element cooperating with drive means to cause the displacement of the device and a support surface designed to rest on a support element.

Yet, problems have arisen with the use of these solutions according to the state of the art.

In fact, these solutions do not guarantee the stability of the storage devices, especially in the case where the latter are of a height greater than the dimensions of their base.

### BRIEF DESCRIPTION OF THE INVENTION

An aim of the present invention is to provide a storage device which solves the abovementioned problems and offers an improved storage device relative to the prior art, especially making transport and locking of these devices easier.

Likewise, an aim of the present invention is to provide devices facilitating the temporary storage then the transport of products of variable volume destined for one or more areas of consumption, while allowing the person or the automaton handling the devices to unequivocally identify the products destined for an area without mixing them up with the products destined for another area.

Another aim of the present invention is to provide a storage device, for example in the form of a mini-container, capable of being handled by robot, especially within the scope of transport fully automated for products destined for an area such as described earlier.

Yet another aim of the present invention is to provide a storage device to be handled while ensuring the stability of the storage device, especially in the case where the latter is of a height greater than the dimensions of its base.

For this purpose, the invention proposes a storage device, such a cassette, especially for the storage of merchandise, the device comprising a storage unit, characterised in that it further comprises:
a rack element (10) designed to cooperate with drive means to cause the displacement of the device or with another rack element to cause the locking of the device,
a support surface (11) designed to cooperate with a support element, the support surface being adjacent to the rack element, and
means designed to cooperate with locking elements.

Thus, according to the circumstances, such a storage device can be positioned precisely, can be stowed or moved, either within warehouses logistics or within the actual transport vehicles

The invention concerns a container adapted for receiving at least one storage device according to the invention, characterised in that the container comprises at least one complementary rack element designed to cooperate with the rack element of the at least one storage device so that the cooperation of the two rack elements causes locking of the at least one storage device within the container.

Advantageously though optionally, the container further comprises at least one locking element of the storage device.

The invention also relates to a displacement device of a storage device according to the invention, the device comprising drive means designed to cooperate with the rack element of the storage device to cause displacement of the storage device.

Advantageously, though optionally, the invention comprises at least one of the following characteristics:
the displacement device further comprises a support element designed to be in contact with the support surface of the storage device to support most of the weight of the storage device,
the displacement means comprise a notched belt,
the displacement means comprise a plurality of toothed wheels,
the displacement means comprise a plurality of flexible cylinders,
the support element comprises a plurality of rollers.

Other characteristics, aims and advantages of the present invention will emerge from the following detailed description, in reference to the attached diagrams, given by way of non-limiting examples and in which:

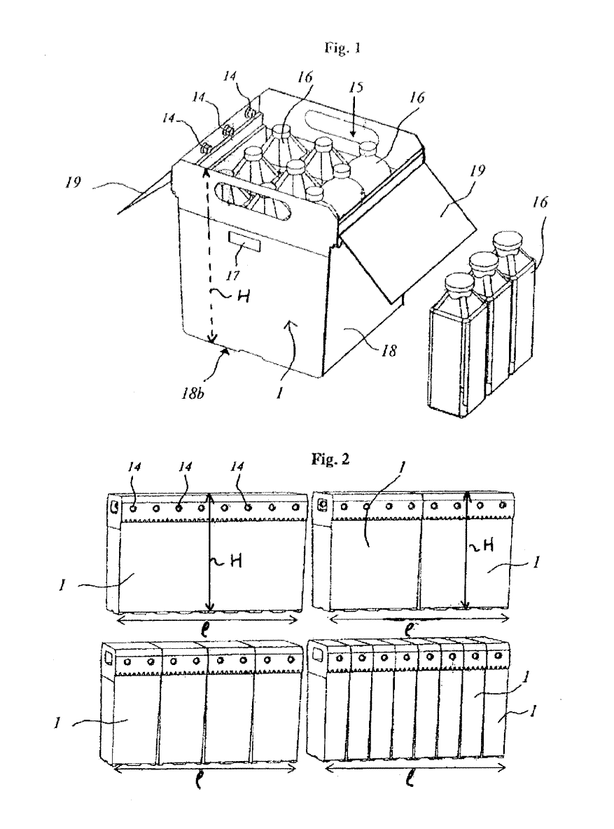

FIG. 1 is a schematic representation in perspective view of a storage device according to a possible realisation of the invention,

FIG. 2 is a schematic representation of several sets of storage devices according to a possible realisation of the invention,

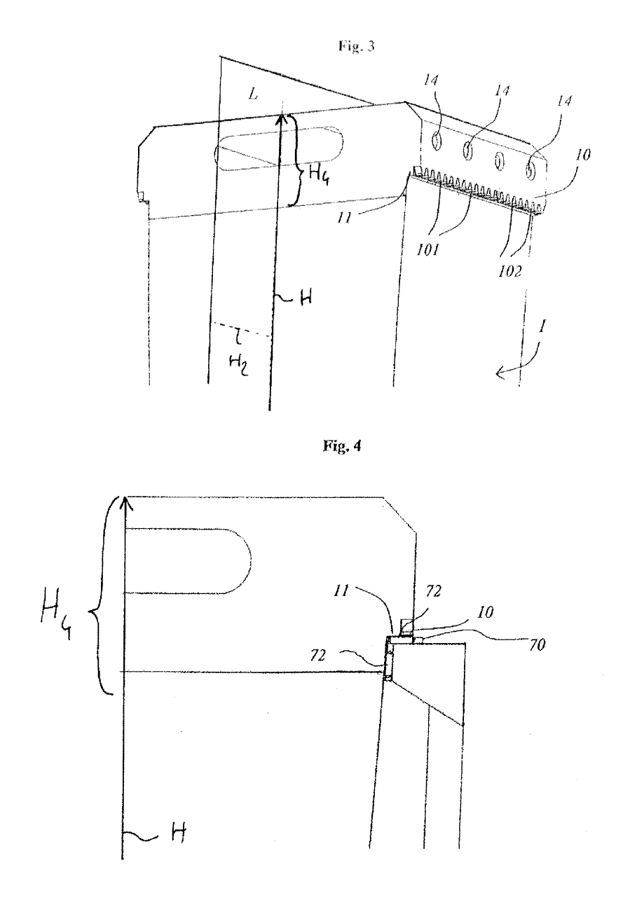

FIG. 3 is a schematic representation in perspective view of a storage device according to a possible realisation of the invention,

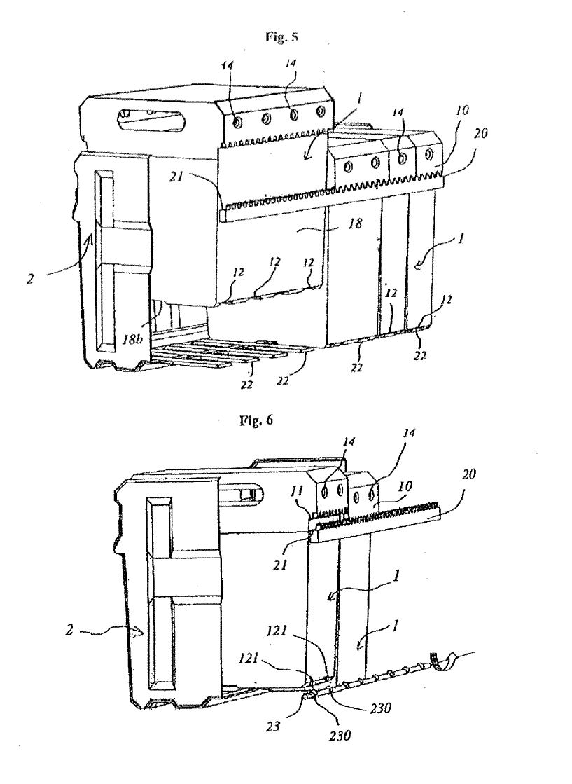

FIG. 4 is a view from a face of a storage device according to a possible realisation of the invention,

FIG. 5 is a schematic representation in perspective view of a container according to a possible realisation of the invention,

FIG. 6 is a schematic representation in perspective view of a container according to a possible realisation of the invention,

FIG. 7 is a schematic representation in perspective view of a displacement device according to a possible realisation of the invention,

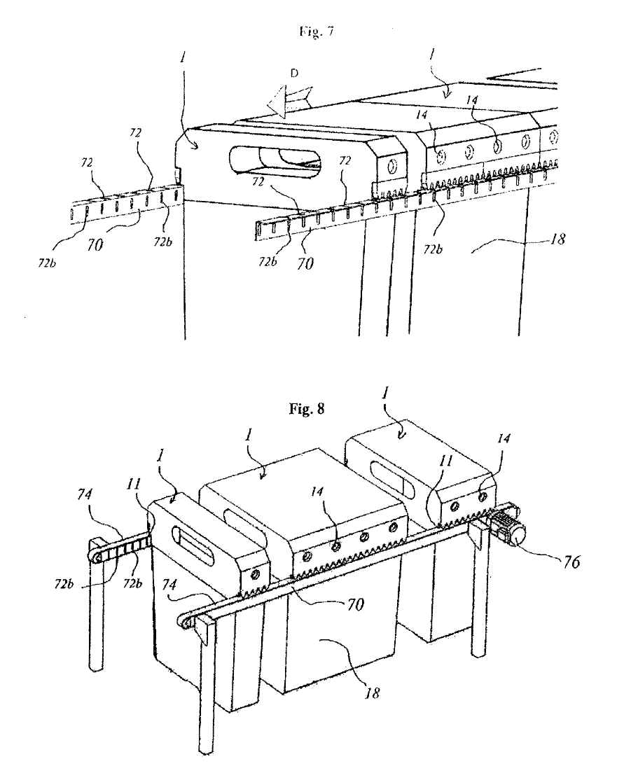

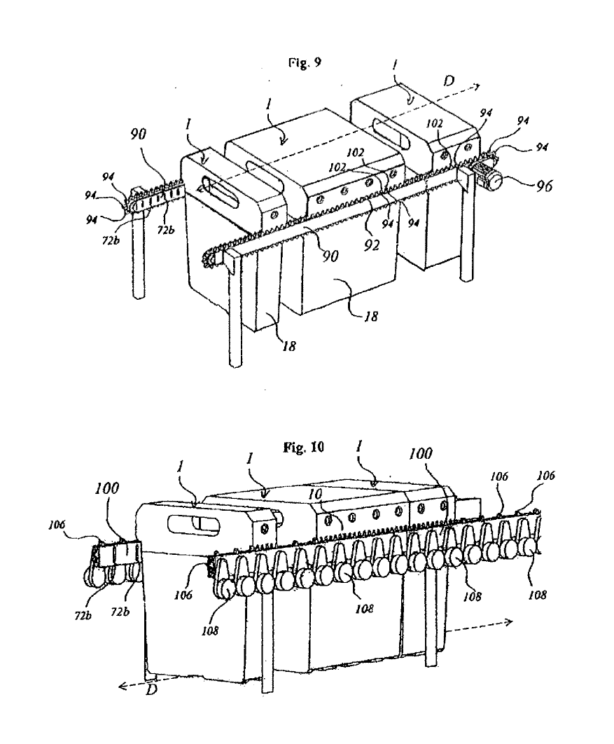

FIG. 8 is a schematic representation in perspective view of a displacement device according to another possible realisation of the invention,

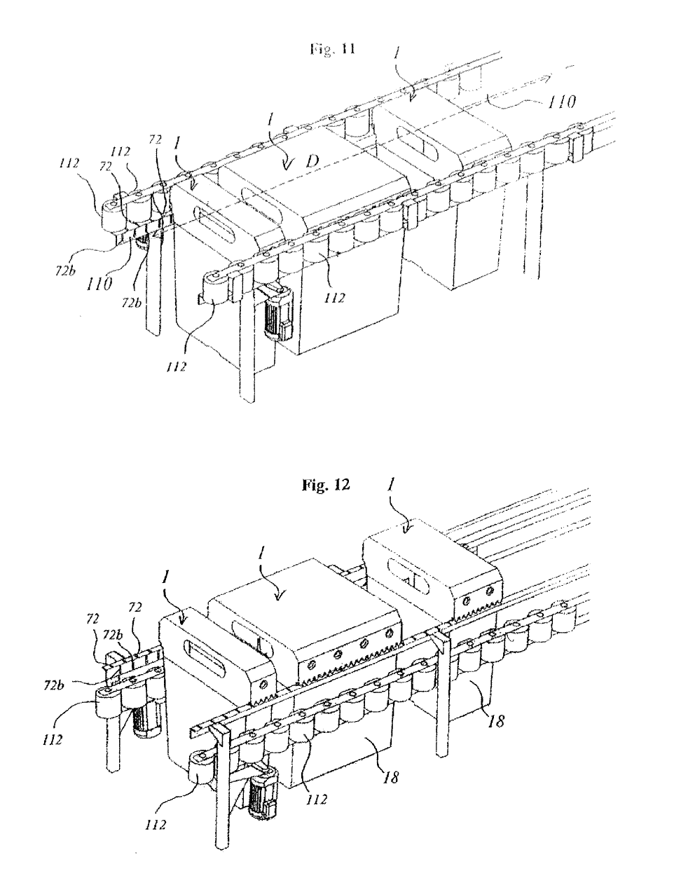

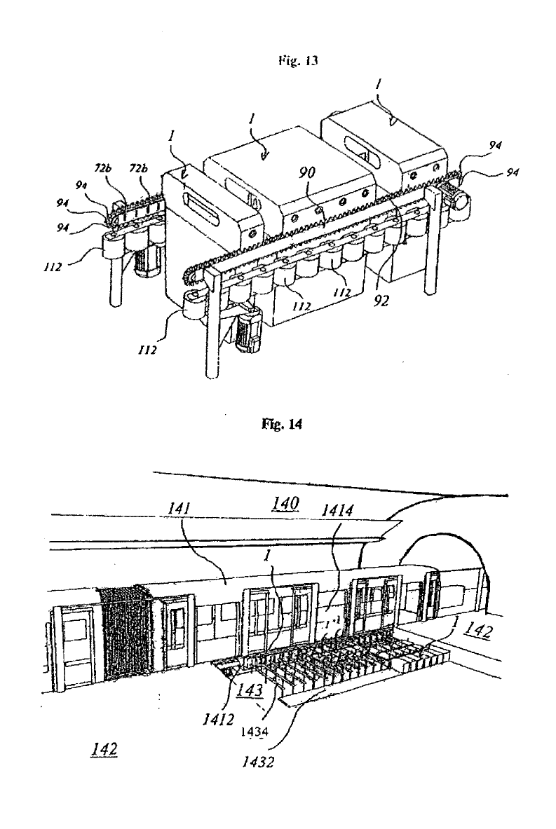

FIG. 9 is a schematic representation in perspective view of a displacement device according to another possible realisation of the invention,

FIG. 10 is a schematic representation in perspective view of a displacement device according to another possible realisation of the invention,

FIG. 11 is a schematic representation in perspective view of a displacement device according to another possible realisation of the invention,

FIG. 12 is a schematic representation in perspective view of a displacement device according to another possible realisation of the invention,

FIG. 13 is a schematic representation in perspective view of a displacement device according to another possible realisation of the invention,

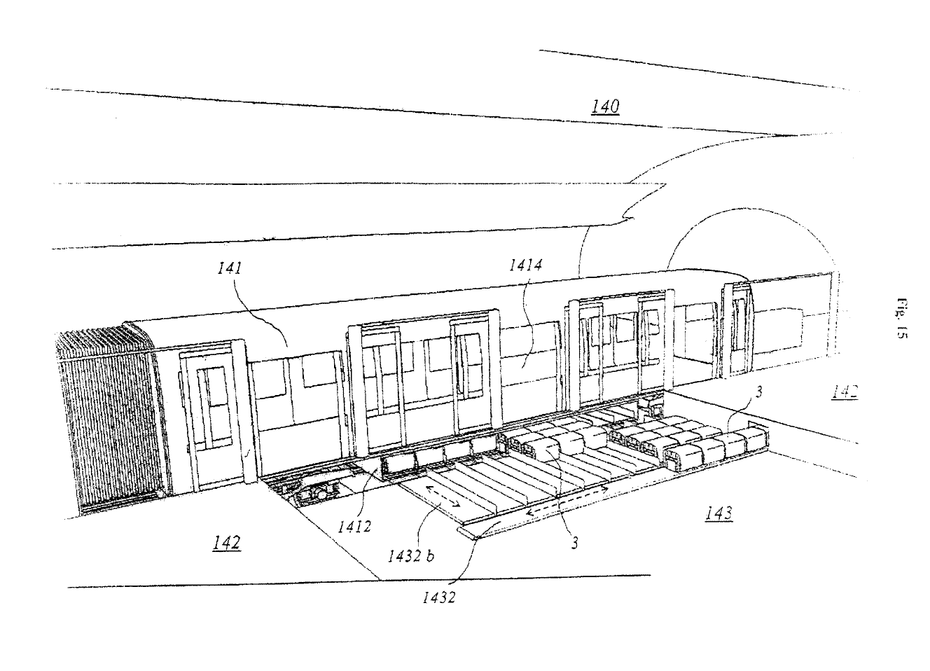

FIG. 14 is a schematic representation in perspective view of a set of a trainset according to another possible realisation of the invention,

FIG. 15 is a schematic representation in perspective view of a trainset according to another possible realisation of the invention.

### DETAILED DESCRIPTION

### Cassette

In reference to Figure I, the cassettes according to a possible realisation of the invention are generally of an approximately parallelepiped rectangle shape and are advantageously closed by a cover 19 comprising one or more parts of height H.

These cassettes 1 form a cavity 15, delimited by a base 18b and a plurality of flanks 18 (generally four). Accordingly it is possible to warehouse products 16 in the cavity 15 provided for this effect.

In reference to FIG. 2, the cassettes preferably have the same cross-section (and therefore the same height H) but have a length (and therefore volume) which is variable such that the same space can accommodate either a single cassette of long length, or a combination of cassettes of lesser length but which can be combined.

For example, let “l” be the length of the largest cassette:
2 cassettes of length l/2
4 cassettes of length l/4
8 cassettes of length l/8
   or any other combination, for example:
1 cassette of length l/2+2 cassettes of length l/4
1 cassette of length l*(6/8)+1 cassette of length l/4
1 cassette of length l*(6/8)+2 cassettes of length l/8
1 cassette of length l/2+1 cassette of length l/4+2 cassettes of length l/8
etc . . .

To ensure handling of the cassette by handling devices to be described later, it is provided that a cassette according to the invention comprises supplementary means such as described hereinbelow.

In reference to FIGS. 3 and 4, each cassette 1 is provided, on either side of its plane of symmetry L, with means 10 and 11 which ensure, according to need, its displacement, its precise positioning and/or its locking.

In general, elements “on either side” of the cassette shall mean the fact that these elements are arranged symmetrically relative to the plane L passing through the median parallel to the height of a flank and the median of an opposite flank.

More precisely, these elements are placed on a level of a high part of the cassette, preferably above the mid-height H2 corresponding to the middle of the height H of the cassette 1. More preferably still, the means 10 and 11 are located. in the last quarter H₄ of the height in the direction of the top of the cassette.

These means 10 and 11 comprise more precisely:
a rack element 10 comprising a longitudinal profile comprising a succession of teeth 101 and hollows 102, the teeth preferably pointing downwards. As illustrated, the succession commences and finishes with a hollow such that juxtaposing two cassettes presents a continuous series of teeth and hollows;
a support surface 11 consisting of a flat longitudinal profile adjacent to the rack element 10 and designed to support the majority or all the weight of the cassette.

By way of advantage and as shown in FIG. 3, the cassette comprises on either side means 10 and 11 such as described earlier.

According to circumstances, these means 10 and 11 interact in combination with handling devices such as described hereinbelow to ensure, according to the case, either the precise positioning and locking of the cassettes, or their displacement.

The cassette 1 also comprises means designed to cooperate with locking elements to ensure their locking, as explained hereinbelow.

### A Handling Device of a Cassette According to the Invention

Handling devices can comprise positioning and locking devices of cassettes or displacement devices of cassettes.

### Positioning and Locking Devices of Cassettes

One of the aims of the present invention is to precisely position the cassettes in a receptacle or vehicle designed for their transport while stowing to prevent the latter from swaying and consequently risking being damaged or damaging the products they contain, even hypothetically where a cassette does not occupy all the space serving as its storage and/or its transport.

In this respect and in reference to FIG. 5, a receptacle 2 such as a mini-container used for the transport of cassettes comprises locking means.

The locking means preferably comprise on either side of the cassette 1:
a complementary rack element 20 placed such that it complements the rack element 10 of the cassette or cassettes 1, and these two rack elements 10 and 20 are joined during insertion of the cassette 1 into the receptacle 2;
a support surface 21 adjacent to the complementary rack element 20 and placed such that it is in contact with the support surface 11 of the cassette 1 during insertion of the cassette 1 into the receptacle 2.

In this embodiment, the support surfaces 21 are located on either side and support most or all of the weight of the cassettes 1 to avoid damage to the rack elements 10 and the complementary rack elements 20 which, in this embodiment, stow the cassettes to prevent them from shifting along the longitudinal axis D.

Advantageously, the device such as described hereinabove is completed by other locking elements of the device and designed to store the cassettes by cooperating with means provided on the cassette. The locking elements preferably comprise at least one of the following elements:
at least one notch 12 located on the base 18b and/or the flanks 18 of the cassettes 1, each notch 12 being positioned on a complementary profile 22 located in the receptacle 2, the interaction between these two elements preventing any swaying of the cassettes 1.
In reference to FIG. 6, at least one camshaft 23 located in the receptacle whereof the cams 230 engage, by rotation, in recesses 121 located on the base and/or the flanks of the cassettes 1.
a hollow and flexible profile which inflates and blocks the cassettes by leaning on their flanks or their base. In this latter case, the cassettes are also blocked in their upper part, for example by complementary means located in the cover of the receptacle 2.

Preferably, the cooperation means with the locking elements are located in the lower part of the cassette 1. More preferably still, the cooperation means with the locking elements are located at the level of the base of the cassette. In fact, the rack elements and the support surface of the storage device of the invention are located at the level of a high part of the device, the latter requiring locking elements in the lower part to prevent swaying along the longitudinal axis D and therefore any damage during potential collisions with other cassettes.

These locking devices have been described with in the scope of a receptacle 2, such as a mini-container, but they can be conceived by the person skilled in the art within the scope of storage space of a transport vehicle of cassettes 1.

### Devices for Displacement of Cassettes

The handling devices can also comprise displacement devices of cassettes.

Displacement of Cassettes by Sliding

First, devices for displacement of cassettes by simple sliding under the effect of gravity or inertia are provided.

For this purpose and in reference to FIG. 7, the support surfaces 11 of the cassettes described hereinabove slide along the longitudinal axis D on flat rails 70, the rails having a low friction coefficient and being advantageously fitted with rollers 72 slightly exceeding the surface width of the rails.

Preferably, the rails are of angled shape whereof the vertical part itself is provided with rollers 72b to guide the cassettes, thus reducing friction by rotating.

Such a device displaces the cassettes 1 with a minimum of effort, by gravity if the support rails are slightly inclined or by simple inertia on horizontal rails if the cassette has previously reached a certain speed.

### Displacement of Cassettes by Entrainment

Second, devices for displacement of cassettes by entrainment by way of displacement devices of cassettes are provided.

The displacement of cassettes itself is ensured by several conceivable devices, non-limiting and inexhaustive examples of which are given below:
Entrainment by Smooth Belts

In reference to FIG. 8, and according to a possible realisation of the present invention, it is provided that the support rails 70 be provided with one or more couples of smooth belts 74 drawn along by one or more motors 76 and on which the surfaces of contacts 11 of cassettes 1 described hereinabove rest.

An advantageous arrangement of this device provides the use of metallic or plastic angles 70 with low friction coefficient, the belt sliding on the upper horizontal part of this angle whereof the vertical part is provided with rollers 72b for laterally guiding the cassettes 1.
Entrainment by Notched Belts

In reference to FIG. 9, the use of rails supports 90 in contact with the support surface 11 of cassettes 1 is provided advantageously for example such as described hereinabove to support most or all of the weight of the cassettes 1 and to facilitate their lateral displacement by sliding. On either side of the cassette a belt or several notched belts 92 are added, pulled he one or more motors 96, and whereof the teeth lodge in the hollow 102 of the rack element 10 of the cassette or cassettes 1.

Such entrainment by notched belts ensures entrainment of the cassettes with sufficient force, for example, to have them climb an inclined plane, even in the case of a heavy load inside the cassettes 1.

A variant consists of attaching to the drive device by notched belt other elements for drawing along cassettes 1, for example acting on the lower part. These can be especially a flexible band provided with profiles and engaging in the notches or the recesses described hereinabove.

Such a drive device with notched belt and attached flexible band can especially overcome steep slopes for the cassettes.
Entrainment by Toothed Wheels

In reference to FIG. 10, it is advantage to use the rails supports 100 in contact with the support surface of cassettes 1, for example such as described hereinabove to support most or all of the weight of the cassettes 1 and to facilitate their displacement with a minimum of effort, to complete this drive device by at least one pair of toothed wheels 106, each wheel of the pair being located on either side of the cassette.

These wheel couples 106 are spaced such that the cassettes are always engaged on at least one couple of toothed wheels 106.

The couple of toothed wheels 106 located opposite are suitable for turning in the same direction to ensure entrainment of cassettes 1 in the same direction. The set of wheels 106 is advantageously slaved (by chain or notched belt, for example) to turn synchronously so that their teeth are positioned conveniently relative to the hollows 102 of the rack elements 10. A set of wheels 106 slaved thus can be actuated by a single motor (not shown).

It is however possible that two adjacent couples (according to the axis D) of wheels 106 are controlled independently so as to be able to turn in opposite directions and shift the cassettes pulled along by each couple of wheels in opposite directions (according to the axis D), which individually pulls along each cassette for example for screening.

Such a variant best places the cassettes 1 in a tight space and shifts each cassette for example to position it precisely in a precise placement (for example an airlock) to make its insertion in a free placement of a receptacle or transport vehicle easy. In this variant, the couples of toothed wheels are drawn by motors 108 (for example stepped motors to obtain a high degree of control precision of the motors).
Entrainment by Flexible Cylinders

In reference to FIG. 11, a first possible realisation consists of using a couple of smooth rails 110 in contact with the support surface 11 of the cassettes 1 to support most or all of the weight of the cassettes and facilitate their displacement and one or more couples of flexible cylinders 112, located on either side of the cassettes 1.

The cylinders must be flexible enough so that they can pull along the cassettes without damaging them as such.

Made of supple material with high friction coefficient, the cylinders 112 of a couple turn in opposite directions to each other and draw the cassettes 1 along by their rotation and friction, ensuring their displacement in a direction according to the axis D.

The flexible cylinders can act on a high part of the cassettes 1 or, preferably, on their flanks 18, as illustrated in FIG. 12. This arrangement has the advantage of avoiding longitudinal swaying of the cassettes as soon as a set of cylinders 112 grips the part of the cassettes most often containing their centre of gravity when they are loaded with products.

Advantageously, it can be provided that the supports of the cylinders 112 comprise elements in the form of an angle whereof the vertical part itself is provided with rollers 72b to guide the cassettes, thus reducing any friction by their rotation. It should be noted that any combination of different displacement devices is feasible.

So, according to a possible variant, the flexible drive cylinders 112 can be attached to the smooth belts described hereinabove to speed up the cassettes, for example.

In reference to FIG. 13, and according to another possible variant, the flexible cylinders can be attached to the drive device by way of the notched belts described hereinabove.

According to another possible variant, it is provided to connect the flexible cylinders to the displacement device by toothed wheels described hereinabove.

All the displacement devices described hereinabove can ensure displacement of the cassettes in the same direction, but at the junction of two drive systems controlled separately can also shift one or more cassettes in a direction opposite to that taken by the other cassettes, constituting for example a screening system.

### Vertical Displacement of Cassettes

In reference again to FIGS. 1 and 2, the cassettes 1 are advantageously provided on either side with means to ensure their vertical displacement.

For this purpose, at least one cavity 14 is provided on either side of the cassette, of parallelepiped or cylindrical shape so as to facilitate insertion of pins of complementary shape belonging for example to a robot arm designed to handling said cassettes 1.

The insertion of at least one pin simultaneously on either side of a cassette 1 allows the robot arm to move the latter vertically to insert or extract it, for example, in or from a receptacle or vehicle designed for its transport.

### Identification of Cassettes

Advantageously and in reference again to FIG. 1, each cassette is provided with at least one “intelligent” identification label 17 of RFID or NFC type which provides all the information useful to its transport (identification of its destination, its transport restrictions, its final destination, its contents . . . ).

Such a label 17 identifies especially the type of cassette which supports it to cooperate with the handling devices of cassettes.

The identification by such remotely searchable labels accordingly allows an automaton to identify the cassettes to be handled with precision and without risk of error.

All the characteristics described above make the cassettes particularly suitable to be handled and sorted fully automatically, especially in warehouses.

It is especially provided to fit out small urban warehouses with the equipment described hereinabove. The recipient of one or more cassettes can have the cassettes delivered automatically, due to the identification labels associated with a warehouse management system.

### Transport of Cassettes

The invention also relates to different modes by which the cassettes can be transported.

The different handling devices of cassettes such as described earlier can be provided inside transport vehicles (for example trucks or vans) to enable cassettes reaching their destination to be unloaded automatically from the transport vehicle (such as a consumption centre, for example).

According to a possible realisation of the present invention, the cassettes can be inserted into standardised mini-containers 3 (for example corresponding to European standard ISO 3394-600×400×400 mm). These dimensions allow an operator to handle the container “with bare hands”.

The fact that the dimensions of the mini-containers are standardised allows modular storage of these mini-containers and their partially or fully automated processing.

The cassettes and the mini-containers can be combined in racks, especially in racks dimensioned to the most commonly used euro-palettes (1200×800 mm or 1200×1200 mm) because of their conformity to the basic European module.

These racks can advantageously be at heights most used by trucks or other transport vehicles to optimise their filling. For the sake of modularity, the racks can constitute homogeneous loads of cassettes or mini-containers or be mixed with ordinary palettes, in mixed loads.

In an urban setting, it is provided that the cassettes or containers may borrow a subterranean network comprising:
a few wide-gauge lines constituting the main arteries of the network. It is provided for example that subterranean metropolitan networks play this role, in downtime (i.e. at night), the cassettes or containers being transported there via racks to reduce multiple handling. It is also provided that wagons are moved so that they can simultaneously transport passengers and cassettes or mini-containers, in their lower part. This device is particularly well adapted to automatic control lines whereof the platforms are provided with entry doors. The precise positioning of wagons when stopped ensures loading and unloading of the cassettes or mini-containers under the platforms, while passengers leave or enter the wagon, as illustrated in FIGS. 14 and 15:
in reference to the latter, at a station 140 designed to receive one or more a trainsets 141 for the transport of persons within a compartment 1414, the people accessing or leaving this compartment via a platform 142 called a “platform”, it is provided a sub-platform 143 located below the platform 142 (in the figure the part of the platform 142 located above the sub-platform 143 has been omitted for clarity). This sub-platform 143 is designed to receive storage cassettes 1 such as described earlier, originating from a storage space 1412 located under the compartment 1414 of the trainset 141. The cassettes 1 are conveyed from the storage space 1412 to the sub-platform 143 by way of shunting means such as jacks or displacement devices 1413 of the cassette 1 such as described earlier and in turn being displaceable to the outside of the storage space for the cassettes to be conveyed to the sub-platform 143. Once introduced within the sub-platform, the cassettes 1 are moved by means of displacement devices 1434 of the sub-platform 143, such as described earlier and conveying the cassettes to a device for subsequent processing of the cassette, such as a belt conveyor 1432, transporting the cassettes 1 to a station for subsequent processing.
according to a variant, and in reference to FIG. 15, standardised mini-containers 3 such as described earlier are transported in the lower part of the wagons, their insertion into or extraction from the wagons being ensured by various means, such as especially belt conveyors 1432 bis, as well as their displacement on the platform 143 (belt conveyor 1432).
minor rapid secondary lines interfaced with the wide-gauge lines for example in warehouses where racks, containers and cassettes are processed automatically. It can be provided that these lines are travelled by small electric traction trains whereof the wagons transport cassettes removed from the mini-containers or racks. The wagons have a cross-section slightly exceeding the width and height of a cassette (400×400 mm). The tunnels of small diameter can easily be placed in the underground to serve the different areas of the town;
a capillary network connected to the rapid secondary lines in which the cassettes are conveyed by small automotor carts, at low speed, in the immediate proximity of the domicile of their recipient (consumption centre), or even at the domicile of the latter, in new buildings made for this purpose. It is provided that the domicile be provided with an airlock for said cassettes allowing the consumption centre to access the contents of the storage cassettes via the airlock opening.

The majority of the transport of merchandise is done underground, so as not to further overload the surface. The transport is preferably driven by electric power, without any pollution and without any noise for the urban population.

Once their contents are unloaded, the cassettes can be used to collect:
empty packaging (empty bottles, special packaging for fragile products such as audio, photo, video . . . ) to appropriate centres where, after possible cleaning (bottles), they could be reused identically, thus decreasing recycling needs;
recyclable waste sorted by category to recycling centres, thus reducing the volume of waste to be landfilled or incinerated:
non-recyclable waste which could be automatically conveyed to landfill or incineration centres. For this purpose, the relevant products could be placed in dedicated bags provided with RFID labels containing information useful for the destination of their contents.

1. A storage device such as a cassette, especially for the storage of merchandise, the device comprising a storage unit, characterised in that it further comprises:
a rack element (10) designed to cooperate with drive means to cause the displacement of the device or with another rack element to cause the locking of the device,
a support surface (11) designed to cooperate with a support element, the support surface being adjacent to the rack element, and
means designed to cooperate with locking elements,

2. A container adapted to receive at least one storage device as claimed in claim 1, characterised in that the container comprises at least one complementary rack element (20) designed to cooperate with the rack element (10) of the at least one storage device (1) so that cooperation of the two rack elements causes locking of the at least one storage device (1) within the container (2).

3. The container as claimed in claim 2, which further comprises at least one locking element (22 or 23) of the storage device (1).

4. A displacement device of a storage device as claimed in claim 1, the displacement device comprising drive means (92, 106, 112) designed to cooperate with the rack element of the storage device (10) to cause displacement of the storage device (1).

5. The displacement device as claimed in claim 4, in which the displacement device further comprises a support element (70, 90, 100) designed to be in contact with the support surface (11) of the storage device to support most of the weight of the storage device.

6. The displacement device as claimed in claim 5 in which the support element (70, 90, 100) comprises a plurality of rollers.

7. The displacement device as claimed in claim 4, in which the displacement means comprise a notched belt (92).

8. The displacement device as claimed in claim 4, in which the displacement means comprise a plurality of toothed wheels (106).

9. The displacement device as claimed in claim 4, in which the displacement means comprise a plurality of flexible cylinders (112).
